(19) United States
(12) Patent Application Publication
(10) Pub. No.: US 2010/0319783 A1
(43) Pub. Date: Dec. 23, 2010

(54) HOT WATER SYSTEM AND THE CONTROL METHOD

(76) Inventor: Si-Hwan Kim, Inchon (KR)

Correspondence Address: Hershkovitz & Associates, LLC, 2845 Duke Street, Alexandria, VA, 22314, US

(21) Appl. No.: 12/742,434

(22) PCT Filed: Oct. 22, 2008
(86) PCT No.: PCT/KR2008/006232

§ 371 Date: Jul. 26, 2010

(30) Foreign Application Priority Data
Nov. 12, 2007 (KR) 10-2007-0114769

(51) Int. Cl. F15D 1/00; F16K 31/02

(52) U.S. Cl. 137/10; 137/486

(57) ABSTRACT

It is an object of the present invention to provide a hot water system that quickly supplies hot water at user's desired temperature and reduce installation cost, and a method of controlling the same According to the present invention, the hot water system includes: a motor, a closing member that controls flow rate of water by rotation of the motor, and a control valve that controls the opening amount of a valve on the basis of output voltage according to a position of the closing member which is changed by the rotation of the motor; a flow rate information measuring unit that measures flow rate information to determine flow rate of water passing through the control valve; a control unit that sets flow rate of water by calculating desired flow rate of water in response to the flow rate information, which is measured by and inputted from the flow rate information measuring unit, and controlling the motor.

### TECHNICAL FIELD

The present invention relates to a hot water system and the control method, more par-ticularly a hot water system that includes a control valve and controls flow rate of direct water to supply hot water or flow rate of heating water that is supplied to each room which needs heating.

### BACKGROUND ART

In general, ‘hot water system’ is an apparatus that produces hot water by heating water flowing through a pipe using a burner, and a boiler and a water heater can be exemplified. A boiler is an apparatus for heating in which heating water that is transported by a circulation pump is heated while passing through a heat exchanger and the heated hot water performs heat exchange through each room that needs heating, and a water heater is an apparatus that supply hot water to a user by heating cold direct water through a heat exchanger.

A hot water distributor that distributes hot water (heating water) to each room that needs heating is provided in the boiler system. The hot water distributor distributes hot water, which is heated by the heat exchanger of the boiler and supplied through a supply pipe, to each room. The supplied hot water transfers heat to each room and is cooled, thereafter returns to the heat exchanger through a return pipe. The hot water distributor is provided with a control valve that controls flow rate of heating water that is supplied to each room.

The control valve is divided into a constant flow type that manually controls flow rate and a proportional control type that controls flow rate by automatically adjusting the opening amount of a valve using a motor on the basis of feed-back information, such as flow rate of heating water.

As for the constant flow type, a user cannot change the flow rate at his/her option once the flow rate is set according to pipe length of each room, such that heating becomes non-uniform when the length of the heating pipe is changed by remodeling or expanding a veranda.

Further, when a flow sensor is used in the proportional control type, the flow rate of the supplied heating water is controlled by controlling the amount of opening of a closing member in response to flow rate data fed-back from the flow sensor, in which the flow sensor may be contaminated due to a lot of contaminants existing in the heating water. Further, when the flow sensor is not used in the proportional control type, the opening amount of the valve is controlled by rotating a stepping motor on the basis of the temperature of the heating water, which is fed-back from a temperature sensor, in which, however, since the stepping motor uses DC power, specific components, such as a transformer and a rectifier, are required and the installation cost increases.

Meanwhile, a water heater system is provided with a flow control valve that measures flow rate of cold direct water flowing through a pipe, using a flow sensor, and controls the supply flow rate of the direct water by adjusting the opening amount of a valve on the basis of measured flow rate that has been fed-back. The flow control valve is provided to supply hot water at user's desired temperature by reducing the flow rate of the direct water, when it is difficult to supply hot water at desired temperature even from the maximum combustion capacity of the water heater due to a great amount of direct water supplied. In this configuration, since flow rate control is performed while feedback is repeated among the flow sensor, a controller, and the flow control valve, response is delayed and hot water at desired temperature cannot be quickly supplied to a user.

### DISCLOSURE OF INVENTION

### Technical Problem

It is an object of the present invention to provide a hot water system that quickly supplies hot water at user's desired temperature and a method of controlling the hot water system.

It is another object of the present invention to provide a hot water system that makes it possible to reduce cost for installing the system, by using an inexpensive alternating current motor.

### Technical Solution

In order to achieve the above objects of the present invention, a hot water system includes: a motor, a closing member that controls flow rate of water by rotation of the motor, and a control valve that controls the opening amount of a valve on the basis of output voltage according to a position of the closing member which is changed by the rotation of the motor; a flow rate information measuring unit that measures flow rate information to determine flow rate of water passing through the control valve; and a control unit that sets flow rate of water by calculating desired flow rate of water in response to the flow rate information, which is measured by and inputted from the flow rate information measuring unit, and controlling the motor.

The control valve is provided with a linear magnet that changes position by the rotation of the motor and a magnetic sensor that detects magnetic flux density that is changed according to the position of the linear magnet.

The control valve is a flow control valve that controls flow rate of direct water that is supplied from a hot water supply system to a heat exchanger and the flow rate information measuring unit is a flow rate sensor that measures flow rate of the direct water passing through the flow control valve.

The control valve is a control valve that controls flow rate of heating water that is supplied to each room in a system distributing heating water to each room that needs heating, and the flow rate information measuring unit is a temperature sensor that measures temperature of the heating water.

A method of controlling a hot water system according to the present invention includes: measuring flow rate information of water flowing through a pipe; setting desired flow rate passing through a control valve, on the basis of the measured flow rate information; setting desired voltage according to positional change of a linear magnet of the control valve, on the basis of the set desired flow rate; changing position of the linear magnet and a closing member by driving a motor of the control valve; and stopping the motor by determining that the desired flow rate is achieved, when potential difference generated in the magnetic sensor by positional change of the linear magnet reaches the desired voltage.

The flow rate information may be flow rate of direct water that flows into a heat exchanger of a hot water supply system.

The flow rate information may be supply temperature or return temperature of heating water.

### ADVANTAGEOUS EFFECTS

According to the hot water system and the method of controlling the hot water system, it is possible to quickly supply hot water at user's desired temperature according to flow rate detected by a flow rate sensor and reduce installation cost.

### BRIEF DESCRIPTION OF DRAWINGS

FIG. 1 is view schematically illustrating the configuration of a hot water system according to an embodiment of the present invention.

FIG. 2 is a cross-sectional view of a flow control valve shown in FIG. 1.

FIG. 3 is a view illustrating the shape and magnetization of a linear magnet that is applied to the flow control valve of the present invention.

FIG. 4 is a graph illustrating the relationship between flow rate and potential difference of a magnetic sensor.

FIG. 5 is a view schematically illustrating the configuration of a hot water system according to another embodiment of the present invention.

FIG. 6 is a cross-sectional view of a control valve shown in FIG. 5.

### BEST MODE FOR CARRYING OUT THE INVENTION

Configurations and operations of preferred embodiments of the invention are described hereafter in detail with reference to the accompanying drawings.

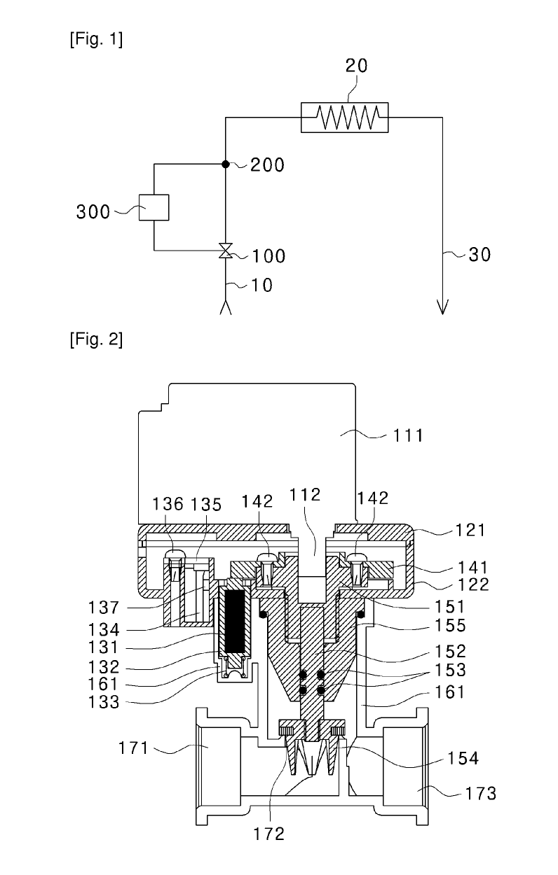

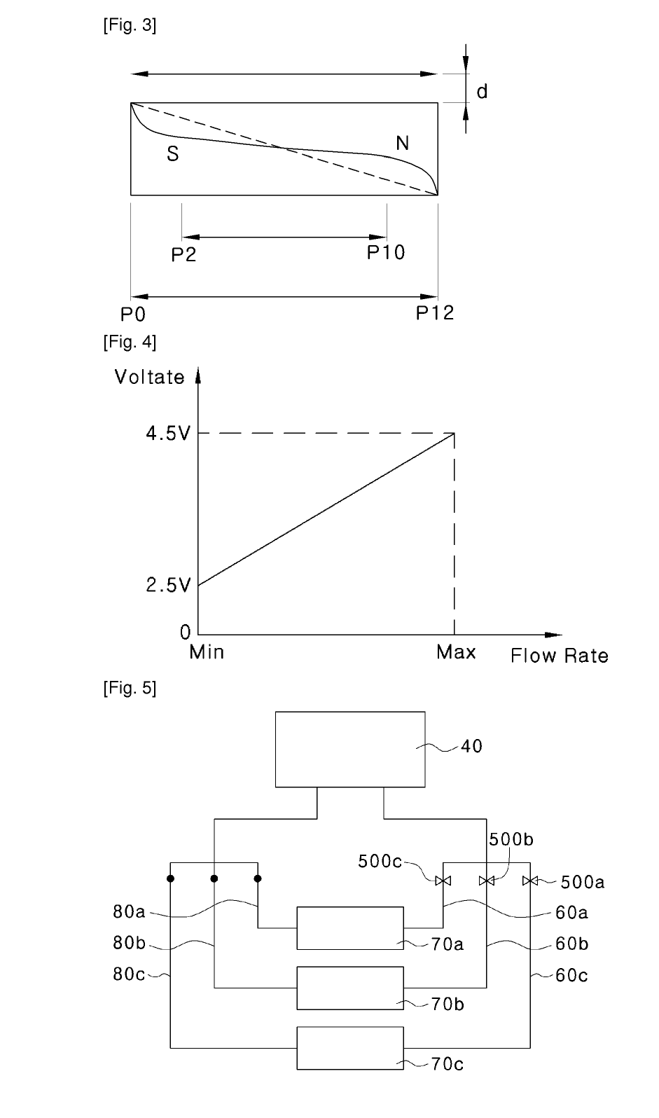

FIG. 1 is view schematically illustrating the configuration of a hot water system according to an embodiment of the present invention, FIG. 2 is a cross-sectional view of a flow control valve shown in FIG. 1, FIG. 3 is a view illustrating the shape and magnetization of a linear magnet that is applied to the flow control valve of the present invention (disclosed in Korean Patent Registration No. 660564), and FIG. 4 is a graph illustrating the relationship between flow rate and potential difference of a magnetic sensor.

Referring to FIG. 1, a hot water system includes a direct water pipe 10 into which cold direct water flow, a heat exchanger 20 where heat is exchanged between direct water flowing through the direct water pipe 10 and high-temperature combustion gas generated by a burner, a heating pipe 30 for supplying hot water passing through the heat exchanger 20 to a user, a flow control valve 100 that is disposed in the direct water pipe 10 and controls flow rate of the direct water, a flow sensor 200 that measures flow rate of the direct water that has passed through the flow control valve 100, and a control unit 300 that calculates needed flow rate on the basis of the flow rate measured by the flow sensor 200 and adjusts the opening amount of the flow control valve 100.

In this configuration, ‘flow rate information’ for setting the flow rate of the direct water passing through the flow control valve 100 in the control unit 300 is actual flow rate measured by the flow sensor 200, and the flow sensor 200 is a means measuring the flow rate information.

Referring to FIG. 2, the flow control valve 100 is provided with a two-way rotary motor 111, a closing member 154 that adjusts the opening amount of a flow channel while reciprocating up/down by rotation of the motor 111, a linear magnet 131 that is variable in position by the rotation of the motor 111, and a printed circuit board 134 that is equipped with a magnetic sensor 137 to control the rotation of the motor 111 by detecting magnetic flux density that changes according to the position of the linear magnet 131.

The motor 111 is rotated by alternating current. Therefore, the cost is reduced as compared with using a motor (e.g. stepping motor) which is driven by direct current because specific components, such as transformer and a rectifier, are not required. A motor shaft 112 provided at the lower portion of the motor 111 is connected to a shaft connecting member 151 and rotated together.

A long bar-shaped metallic shaft 152 is connected to the lower portion of the shaft connecting member 151 to integrally rotate. The closing member 154 that opens/closes an opening 172 forming a flow channel for direct water is connected to the lower portion of the shaft 152. Reference numeral not stated herein designates an O-ring.

A circular disc-shaped rotary plate 141 where the motor shaft 112 is inserted at the center potion is disposed on the shaft connecting member 151. The shaft connecting member 151 and the rotary plate 141 are combined by two screws.

A magnet case 132 is disposed with the upper end being in contact with the lower outer side of the rotary plate 141. The magnet case 132 is made of synthetic resin and has the linear magnet 131 therein, and the lower surface of the magnet case 132 is elastically supported by a spring 133 and inserted in a magnet accommodating portion 162 formed at the upper end of a side of a valve outer body 161.

A printed circuit board 134 accommodated in a lower case 122 is disposed at a side of the linear magnet 131. The magnetic sensor 137 that detects the magnetic flux density according to positional changes of the linear magnet 131 is attached to the printed circuit board 134. A cover 135 is fixed to the upper portion of the printed circuit board 134 by a screw 136 to cover the printed circuit board 134.

The ‘linear magnet’ described herein implies a magnet having straightness (linearity) in change of magnetic flux density according to displacement, and the linear magnet 131 and the magnetic sensor 137 are described hereafter.

Referring to FIG. 3, the linear magnet 131 is magnetized with North Pole and South Pole in a sine wave shape in the orthogonal direction from the left upper edge of a rectangle.

In general, it has been known that the magnetic flux density is in inverse proportion to the square of distance. Therefore, in common magnets, changes in magnitude of the magnets according to displacement construct a quadratic function graph and do not have linearity.

On the contrary, as shown in FIG. 3 in which the shape of the magnet is shown by a dotted line, the magnetic flux density of the north pole according to displacement does not show linearity when the linear magnet 131 that is applied to the present invention is magnetized such that the magnetic wall is formed in the orthogonal direction; however, as shown by a solid line, the magnet is magnetized such that the magnetic wall makes a sine wave in the orthogonal direction, the magnetic flux density shows linearity.

In FIG. 3, the magnetic sensor 137 detects changes in magnetic flux according to positional changes of the linear magnet 131. That is, the magnetic sensor 137 is disposed at a predetermined distance d from the polar surface of the linear magnet 131 and the linear magnet 131 makes the polar surface move on the same plane. Accordingly, P0 to P 12, which is a polar surface section of the linear magnet 131 maintain the same distance d while passing through the magnetic sensor 137, in which values of the magnetic flux density detected by the magnetic sensor 1317 linearly changes. However, both ends of P0 to P12, which is the polar surface section of the magnet, slightly show non-linearity; therefore, it is preferable to select P2 to P10 having good linear characteristics as a use section, except for the above portions.

The magnetic sensor 131 that is used to measure changes in magnetic flux density according to changes in position of the linear magnet 137 is a Hall sensor (Programmable Hall IC) that is commonly used as one of means detecting magnetic field. When a magnetic field is vertically applied after current is applied to an electrode of a semiconductor (hall element), potential difference is generated vertical to the direction of the current and the direction of the magnetic field, such that the Hall sensor can detect changes in position of the linear magnet 137 from the potential difference (electric potential).

A process of setting flow rate in the flow control valve 100, that is, a method of controlling the hot water system is described hereafter with reference to FIGS. 1 to 4.

When a user turns on the tap to use hot water for example, the flow sensor 200 measures flow rate and a burner (not shown in the drawings) is ignited and heat is supplied to the heat exchanger 20.

Flow rate measured by the flow sensor 200 and temperature of direct water measured by a direct water sensor (not shown) provided on the direct water pipe 10 are inputted into the controller 300, while desired temperature of the hot water is set in advance. Thereafter, the required quantity of heat for increasing the temperature of the direct water to the desired temperature is calculated in the control unit 300, by the following equation,

Q=mc×Δt

where, m is flow rate, c is specific heat, 1, and ?t is difference of the desired temperature and the current temperature of the direct water.

When the capacity of the boiler (the maximum suppliable quantity of heat) is smaller than the required quantity of heat calculated from the above equation, hot water at user's desired temperature cannot be supplied even if combustion is performed at the maximum heating power in the burner. Therefore, the control unit 300 calculates desired flow rate for reducing the flow rate of the direct water and controls the flow control valve 100.

As shown in FIG. 4, the relationship between the flow rate and the voltage detected by the magnetic sensor 137 according to positional changes of the linear magnet 131 is set in advance.

That is, the voltage to the position of the linear magnet 131 is set to as 4.5V when passable flow rate is the maximum flow rate by fully opening the flow control valve 100, the voltage to the position of the linear magnet 131 is set to as 0.5V when passable flow rate is the minimum flow rate by fully closing the flow control valve 100, and the voltage values when the open position of the flow control valve 100 is between the maximum flow rate position and the close position are linearly proportional due to linearity of the linear magnet 131.

Therefore, the control unit 300 sets a desired voltage for the desired flow rate on the basis of the graph data shown in FIG. 4, and reduces the flow rate by rotating the motor 110 of the flow control valve 100 to move the closing member 154 down.

As the rotary plate 141 moves down while rotating with the motor 111, the linear magnet 131 correspondingly moves down. When the potential difference generated in the magnetic sensor 137 according to positional sensor of the linear magnet 131 reaches the desired voltage, the control unit 300 determines that the desired flow rate is achieved, and stops the operation of the motor 111.

Minute adjustment is performed because there is a small difference between the actual flow rate and the desired flow rate after the desired flow rate is achieved; however, the desired flow rate can be achieved by operating only one time the motor 111 when the flow rate is controlled by the above process, such that hot water at user's desired temperature can be quickly supplied.

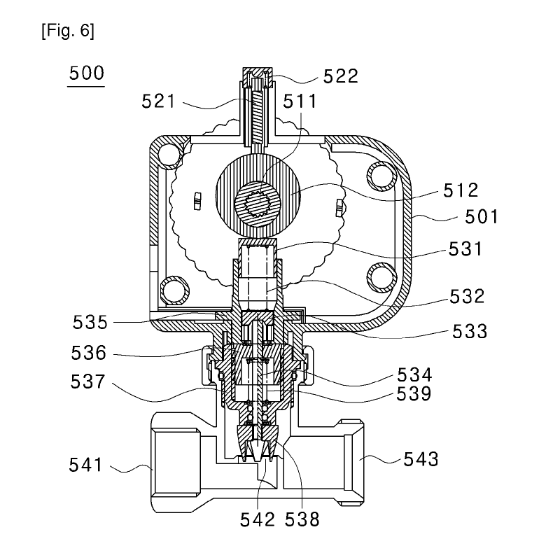

FIG. 5 is a view schematically illustrating the configuration of a hot water system according to another embodiment of the present invention and FIG. 6 is a cross-sectional view of a control valve shown in FIG. 5.

The ‘hot water system’ described in this embodiment implies a heating system for heating.

Referring to FIG. 5, the hot water system includes a heat source 40 that supplies heating water (hot water) by heating water for district heating or individual heating, a distributor 50 that distributes the heating water supplied from the heat source 40 to each of rooms 70a, 70b, 70c, supply pipes 60a, 60b, 60c that connect the distributor 50 with the rooms 70a, 70b, 70c, return pipes 80a, 80b, 80c through which the heating water, which has been heat-exchanged with the rooms 70a, 70b, 70c, passes through, and control valves 500a, 500b, 500c that are disposed in the supply pipes 60a, 60b, 60c and control flow rate of the heating water that is supplied to the rooms 70a, 70b, 70c.

In this embodiment, ‘flow rate information’ for setting the flow rate of the heating water passing through the control valve 500 by the control unit may be the temperature of the heating water distributed to each room that needs heating, in which the temperature sensor (not shown in the drawings) measuring the temperature of the heating water is a mean for measuring the flow rate information.

Referring to FIG. 6, the control valve 500 includes a motor (not shown in the drawing) disposed in a case 501, a closing member 538 that adjusts the opening/closing amount of the flow channel for the heating water by reciprocating up/down by rotation of a motor shaft 511 of the motor, a cam member 512 that is connected to the motor shaft 511 to integrally rotate while being biased from the motor shaft 511, a linear magnet 521 that is elastically supported by a spring to be always in contact with the outer circumference of the cam member 512 that is rotating, and changes the up-down position along the outer circumference of the cam member 512, a magnetic sensor (not shown in the drawing) that is disposed close to the linear magnet 521 to control the rotation of the motor by detecting the magnetic flux density, which is changed according to the position of the linear magnet 521, and a printed circuit board (not shown in the drawing) equipped with the magnetic sensor, a cam contact member 531 that is elastically supported by a spring 532 to be in contact with the lower outer circumference of the cam member 512, open downward, and changes the up-down position by rotation of the cam member 512, an upper guide member 535 that guides up-down motion of the cam contact member 531, a shaft contact member 533 that is inserted in the guide member 535, with the upper surface being contact with the spring 532 and the lower surface being in contact with and supported by the upper end of the shaft 534, a locking rotary member 536 and a lower guide member 537 in which the shaft 534 is inserted and which guide the outer circumference of the shaft 534 that reciprocates up/down, a spring 539 that is compressed when the shaft 534 moves down, a closing member 538 that is connected to the lower end of the shaft 534 and closes an opening 542 formed between an inlet 541 and an outlet 543 for heating water, in which the linear magnet 521 implies the same linear magnet shown in FIG. 3.

A process of setting flow rate in the control valve 500, that is, a method of control the hot water system (heating system) is described hereafter with reference to FIGS. 5 and 6.

Flow rate of heating water that is supplied to the rooms 70a, 70b, 70c are different depending on the lengths of the pipe provided in each of the rooms 70a, 70b, 70c, and temperature for heating the rooms 70a, 70b, 70c may also be set different each other.

Therefore, for example, the control unit sets desired flow rate, in consideration of the temperature of heating water (supply temperature of return temperature) measured by the temperature sensor and the temperature set by a user.

Depending on the desired flow rate set as described above, desired voltage according to positional change of the linear magnet 521 of the control valve 500 is set, in which the desired voltage can be obtained from graph data shown in FIG. 4.

After the desired voltage is determined, the cam member 512 is rotated by the motor, the closing member 538 changes the up-down position by the rotation of the cam member 512 while the linear magnet 521 that has been in contact with the cam member 512 correspondingly changes the up-down position.

As the position of the linear magnet 521 is changed, the potential difference of the magnet sensor is changed. When the potential difference reaches the desired voltage, it is determined that the desired flow rate through the control valve 500 is achieved, the motor is stopped.

Although it is described above that a linear magnet is used to detect the opening amount of the valve, it may be possible to substitute a variable resistance and a variable inductance for the linear magnet and the magnet sensor.

As for using a variable resistance, output voltage of the variable resistance according to the opening amount of the valve is set in advance, and when the contact point of the resistance is changed by the rotation of the motor, the opening amount of the valve can be detected by corresponding output voltage.

Further, as for using a variable inductance, output voltage of the variable inductance according to the opening amount of the valve is set in advance, and when the position of the magnet is changed in a coil according to the rotation of the motor, the opening amount of the valve can be detected by corresponding output voltage.

### INDUSTRIAL APPLICABILITY

According to a hot water system where the present invention is applied as described above, it is possible to quickly supply hot water at user's desired temperature, in accordance with flow rate detected by a flow rate sensor and to reduce cost required to install the hot water system.

1. A hot water system comprising:
a motor, a closing member that controls flow rate of water by rotation of the motor, and a control valve that controls the opening amount of a valve on the basis of output voltage according to a position of the closing member which is changed by the rotation of the motor;
a flow rate information measuring unit that measures flow rate information to determine flow rate of water passing through the control valve; and
a control unit that sets flow rate of water by calculating desired flow rate of water in response to the flow rate information, which is measured by and inputted from the flow rate information measuring unit, and controlling the motor.

2. The hot water system according to claim 1, wherein the control valve is provided with a linear magnet that changes position by the rotation of the motor and a magnetic sensor that detects magnetic flux density that is changed according to the position of the linear magnet.

3. The hot water system according to claim 1, wherein the control valve is a flow control valve that controls flow rate of direct water that is supplied from a hot water supply system to a heat exchanger and the flow rate information measuring unit is a flow rate sensor that measures flow rate of the direct water passing through the flow control valve.

4. The hot water system according to claim 1, wherein the control valve is a control valve that controls flow rate of heating water that is supplied to each room in a system distributing heating water to each room that needs heating, and the flow rate information measuring unit is a temperature sensor that measures temperature of the heating water.

5. A method of controlling a hot water system, comprising:
measuring flow rate information of water flowing through a pipe;
setting desired flow rate passing through a control valve, on the basis of the measured flow rate information;
setting desired voltage according to positional change of a linear magnet of the control valve, on the basis of the set desired flow rate;
changing position of the linear magnet and a closing member by driving a motor of the control valve; and
stopping the motor by determining that the desired flow rate is achieved, when potential difference generated in the magnetic sensor by positional change of the linear magnet reaches the desired voltage.

6. The method of controlling a hot water system according to claim 5, wherein the flow rate information is flow rate of direct water that flows into a heat exchanger of a hot water supply system.

7. The method of controlling a hot water system according to claim 5, wherein the flow rate information is supply temperature or return temperature of heating water.
